(19) United States
(12) Patent Application Publication
(10) Pub. No.: US 2008/0145181 A1
(43) Pub. Date: Jun. 19, 2008

(54) Tamper Resistant Fastener

(76) Inventors: Benjamin C. Lynes, Wales (GB); Benjamin J. Cooper, Surrey (GB)

Correspondence Address: RYAN KROMHOLZ & MANION, S.C., POST OFFICE BOX 26618, MILWAUKEE, WI, 53226, US

(21) Appl. No.: 11/793,934

(22) PCT Filed: Dec. 6, 2005
(86) PCT No.: PCT/GB2005/004686

§ 371 Date: Nov. 27, 2007

(30) Foreign Application Priority Data
Dec. 23, 2004 (GB) 0428209.1
Sep. 9, 2005 (GB) 0518448.6

(51) Int. Cl. F16B 23/00; F16B 37/00; B25B 13/06

(52) U.S. Cl. 411/403; 411/436; 81/125

(57) ABSTRACT

A tamper resistant fastener includes a body (10) of substantially circular cross-section having a plurality of depressions (15′) formed in its surface. Each depression (15′) has a curved concave surface (16′) at one end and a curved convex surface (17′) at its other end. The depressions are engageable by a tool whereby the fastener can be turned in one direction by the tool to engage the fastener and, once engaged, the fastener can only be turned in the opposite, unfastening direction when engaged by the tool. The fastener may take the form of a nut or a screw or a screw-threaded bolt.

This invention relates to tamper resistant fasteners such as screws and screw-threaded nuts and bolts which are designed at least to discourage if not prevent unauthorised removal.

It has previously been proposed in GB2269644A to provide a security nut comprising a body having opposite ends of greater and lesser diameter respectively and an external surface of generally domed shape between said ends. A threaded bore extends between the ends and a plurality of grooves are provided in the domed surface and extend between the ends. One wall of each groove lies in a plane generally radial to the longitudinal axis of the bore and the other wall diverges, in a direction from the base of the groove, from the one wall. The groove walls are so arranged that the nut can be tightened onto a male threaded member received in the bore by torque applied to the nut by engagement of said one walls by a suitable tool but the inclination of the said other walls prevents torque being applied to the nut by engagement of said other walls so that the nut cannot be slackened from the male threaded member.

The present invention aims to provide an improvement on this known arrangement.

According to the present invention, there is provided a tamper-resistant fastener including a body of substantially circular cross-section having a plurality of depressions formed in its surface wherein each depression has a curved concave surface at one end and a curved convex surface at its other end, the depressions being engageable by a tool whereby the fastener can be turned in one direction by the tool to engage the fastener and, once engaged, the fastener can only be turned in the opposite, unfastening, direction when engaged by the tool.

The fastener according to the present invention provides an improvement over the known fastener in that it can be unfastened by the special engagement tool and yet cannot be unfastened by any other tool thus providing a secure and tamper-resistant fastening which, at the same time, is releasable.

Preferably, an odd number of depressions are provided. The preferred number of depressions is five but three or seven or even more depressions could be provided.

Preferably, the fastener is provided with a screw thread and may take the form of a nut, bolt or screw. The nut or the head of the bolt or screw may be cylindrical, or frusto-conical or domed. The depressions are desirably tapered from one end of the nut or head to the other.

The invention also extends to a tool for use with a fastener according to the invention.

The invention will now be described in detail, by way of example, with reference to the drawings in which:—

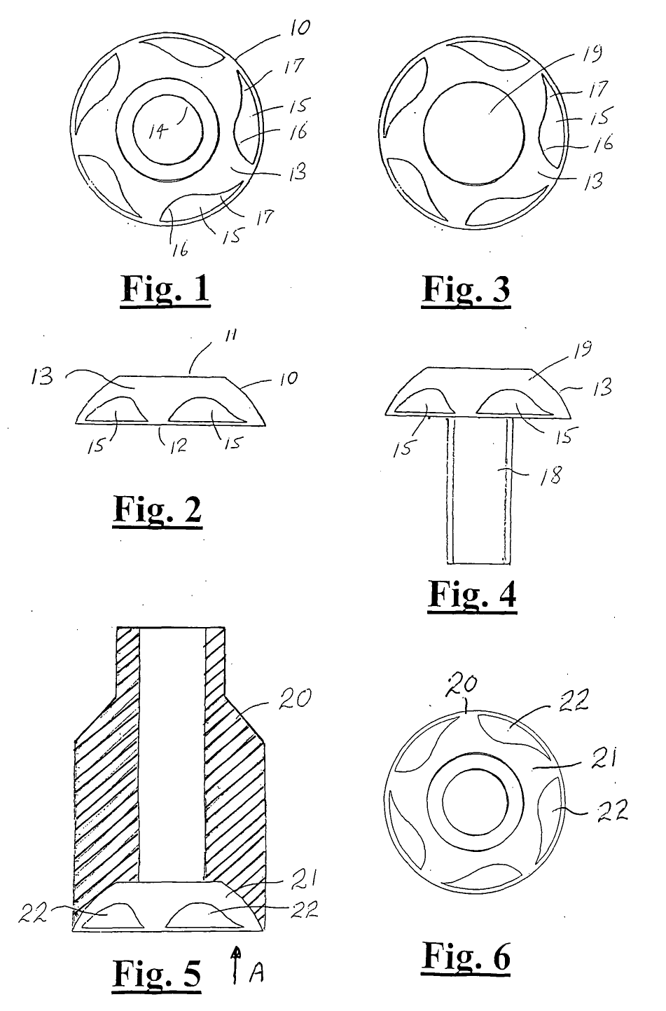

FIG. 1 is a plan view of one embodiment of a nut according to the invention;

FIG. 2 is a side elevation of the nut shown in FIG. 1;

FIG. 3 is a plan view of one embodiment of a screw according to the invention;

FIG. 4 is a side elevation of the screw shown in FIG. 3;

FIG. 5 is a vertical section through a tool for use with the nut shown in FIGS. 1 and 2 and/or the screw shown in FIGS. 3 and 4;

FIG. 6 is an end view of the tool shown in FIG. 5 in the direction of the arrow A;

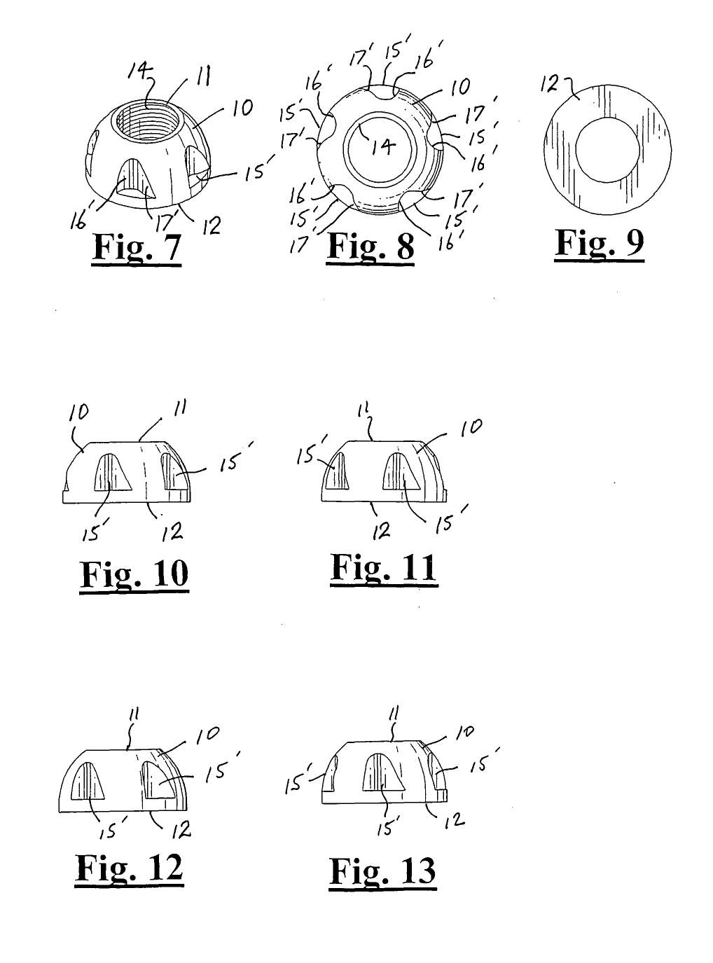

FIG. 7 is a perspective view of a second embodiment of a nut according to the invention;

FIG. 8 is a plan view of the nut shown in FIG. 7;

FIG. 9 is an underneath plan view of the nut shown in FIG. 7;

FIG. 10 is a front view of the nut shown in FIG. 7;

FIG. 11 is a rear view of the nut shown in FIG. 7;

FIG. 12 is a view of one side of the nut shown in FIG. 7;

FIG. 13 is a view of the other side of the nut shown in FIG. 7;

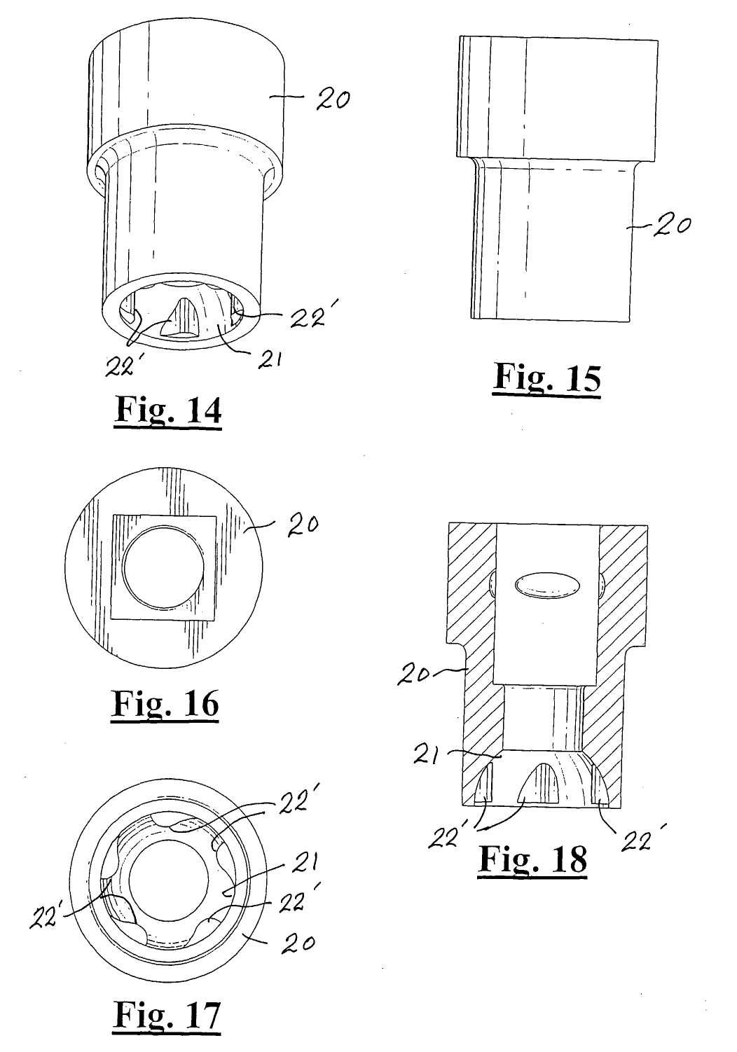

FIG. 14 is a perspective view of a tool for use with the nut shown in FIGS. 7 to 13;

FIG. 15 is a front view of the tool shown in FIG. 14;

FIG. 16 is a plan view of the tool shown in FIG. 14;

FIG. 17 is an underneath plan view of the tool shown in FIG. 14; and

FIG. 18 is a vertical section taken on the line A-A in FIG. 15 in the direction of the arrows.

In the drawings, like parts are denoted by like reference numerals.

Reference will first be made to FIGS. 1 and 2 of the drawings in which the nut comprises a body 10 having opposite ends 11 and 12 of lesser and greater diameter respectively. The external surface 13 of the nut between the ends 11 and 12 is dome-shaped and is part-spherical. The nut has a central screw-threaded bore 14.

A plurality of depressions 15 are formed in the external surface of the body 10. All of the depressions are similar and are equiangularly spaced around the longitudinal axis of the bore 14. Each depression 15 has a curved concave surface 16 at one end and a curved convex surface 17 at the other end.

The arrangement is such that the nut can be tightened by a force applied to the curved surfaces 16 to tighten the nut on a male screw-threaded member received in the bore 14. Once the nut has been tightened, the curved surfaces 17 prevent a torque being applied to the nut by engagement of these surfaces to slacken the nut. Any tool other than a specially designed tool will simply slip round the nut because of the shape of the curved convex surfaces 17 and the part-spherical shape of the nut will prevent engagement by pliers or the like.

It will thus be seen that the nut may be used where security is required since it may be tightened up onto a bolt but not untightened.

The nut may be tightened using the tool shown in FIGS. 5 and 6. The tool is in the form of a socket member 20 engageable by a driving bar or the like (not shown). The end of the socket member is provided with a recess 21 and in the recess are formed curved projections 22 which are the mirror images of the depressions in the nut.

The nut is driven by placing the recess 21 in the socket member 20 of FIGS. 5 and 6 over the nut so that the curved projections 22 of the socket engage in the depressions 15 in the nut and then turning the nut to tighten it. If the direction of movement of the socket is reversed the nut can be slackened.

FIGS. 3 and 4 show a screw embodying the invention. The screw has a shank 18 and a head 19. The head is dome shaped and has depressions 15 therein which have the same configuration as those in the nut. The bolt can be tightened by inserting the head thereof in the recess 21 of the socket 20 so that the curved projections 22 engage in the depressions 15 on the bolt head and turning the socket. The invention is equally applicable to bolts and a nut as shown in FIGS. 1 and 2 may be engaged with the screw-threaded shank of the screw or bolt.

FIGS. 7 to 13 show a second embodiment of a nut according to the invention. The nut is essentially similar to the nut shown in FIGS. 1 and 2 except that the depressions 15′ are slightly smaller, in relation to the size of the nut, than the depressions 15 in FIGS. 1 and 2 in the circumferential direction of the nut and slightly greater in the axial direction of the nut. Again, each depressions 15′ has a curved concave surface 16′ at one end and a curved convex surface 17′ at the other end.

A tool for use with the nut shown in FIGS. 7 to 13 is illustrated in FIGS. 14 to 18 of the drawings. In this case, the socket member 20 has in its recess 21 curved projections 22′ which are mirror images of the depressions 15′ in the nut. Thus, the nut shown in FIGS. 7 to 13 can only be fastened by the tool shown in FIGS. 14 to 18 and, once fastened, the nut only be unfastened with the same tool.

Although not shown in the drawings, it will be appreciated that the head of screw or a screw-threaded bolt could be provided with depressions 15′ in a similar manner to the screw shown in FIGS. 3 and 4.

The nuts, screws and bolts described above may be made of any convenient material e.g. steel or plastic and if made of steel may be galvanised.

It will be seen that the invention provides a nut, screw or bolt having a security feature in that it can be tightened and slackened only by a specially designed tool.

The fastener according to the invention therefore provides an improvement over existing tamper-resistant fasteners in that it is releasable but only with a special tool.

The invention is not restricted to the above-described embodiments but variations and modifications may be made without departing from the scope of the invention. For example, although five depressions 15,15′ have been illustrated this is not essential and more or less than five depressions may be provided. It is preferred that an odd number of depressions be provided but, again, this is not essential. The tool must of course have the same number of projections as the nut or screw or bolt head with which the tool is to be used. Further, although the above-described fasteners have been provided with screw-threads, this is again not essential and other fastening means, such as a bayonet connection, may be utilised.

1. A tamper-resistant fastener comprising a body of substantially circular cross-section having a plurality of depressions formed in its surface wherein each depression has a curved concave surface at one end and a curved convex surface at its other end, the depressions being engageable by a tool whereby the fastener can be turned in one direction by the tool to engage the fastener and, once engaged, the fastener can only be turned in the opposite, unfastening direction when engaged by the tool.

2. A tamper resistant fastener according to claim 1, wherein an odd number of depressions are provided.

3. A tamper resistant fastener according to claim 2, wherein five depressions are provided.

4. A tamper resistant fastener according to claim 1, wherein the fastener is provided with a screw-thread.

5. A tamper resistant fastener according to claim 4, wherein the fastener takes the form of a nut.

6. A tamper resistant fastener according to claim 5, wherein the outer surface of the nut is one selected from the group consisting of cylindrical, frusto-conical and dome-shaped.

7. A tamper resistant fastener according to claim 4, wherein the fastener takes the form of one of a screw and a screw-threaded bolt having a head in which the depressions are provided.

8. A tamper resistant fastener according to claim 7, wherein the head of the screw is one selected from the group consisting of cylindrical, frusto-conical and dome-shaped.

9. A tamper resistant fastener according to claim 5, wherein the depressions are tapered from one end of the nut to the other.

10. A driver tool for use with the fastener claimed in claim 1, said driver tool having a socket formed with projections, each projection having a curved convex surface at one end and a curved concave surface at its other end and being adapted to engage in a respective depression in the fastener.

11. A tamper resistant fastener according to claim 7, wherein the head of the bolt is one selected from the group consisting of cylindrical, frusto-conical and dome-shaped.

12. A tamper resistant fastener according to claim 5, wherein the depressions are tapered from one end of the head to the other.
